(19) United States
(12) Patent Application Publication
(10) Pub. No.: US 2020/0107084 A1
(43) Pub. Date: Apr. 2, 2020

(54) METHOD AND DEVICE FOR PLAYBACK OPTIMIZATION

(71) Applicant: (HEYI INTELLIGENT TECHNOLOGY SHENZHEN) CO., LTD., Beijing (CN)

(72) Inventors: Chao NING, Beijing (CN); Shenhua AN, Beijing (CN); Qian CAO, Beijing (CN); Wenhua SU, Beijing (CN); Jian YAO, Beijing (CN); Baiyu PAN, Beijing (CN); Ji WANG, Beijing (CN)

(21) Appl. No.: 16/095,003

(22) PCT Filed: Sep. 12, 2016
(86) PCT No.: PCT/CN2016/098658

§ 371 Date: Oct. 19, 2018

(30) Foreign Application Priority Data
Apr. 28, 2016 (CN) 201610280127.2

(51) Int. Cl. H04N 21/845; H04L 29/06; H04N 21/2343; G11B 27/34; G11B 27/034

(52) U.S. Cl. CPC H04N 21/8456; H04L 65/4084; H04L 65/80; G11B 27/034; H04L 65/607; G11B 27/34; H04N 21/23439

(57) ABSTRACT

The present disclosure relates to a method and device for playback optimization. The method specifically includes: upon receiving a request from a client, querying whether an optimized playback parameter related to a multimedia resource has been stored, wherein the request is associated with the multimedia resource; and if the optimized playback parameter has been stored, transmitting the optimized playback parameter to the client, so as to have the multimedia resource played by the client according to the optimized playback parameter. The method of playback optimization of embodiments of the present disclosure allows hardware advantage to be brought into play in the process of multimedia resource playback, thus enhancing playback effects. Moreover, an assessment of the content of the entire multimedia resource can be performed, thus emphasizing an idea being expressed by a picture, and enhancing comprehension of the content of the picture.

### RELATED APPLICATIONS

This application is a 35 U.S.C. § 371 national stage filing of International Application No. PCT/CN2016/098658, filed on Sep. 12, 2016, which claims priority to Chinese Patent Application No. 201610280127.2, filed on Apr. 28, 2016. The entire contents of each of the foregoing applications are incorporated herein by reference.

### TECHNICAL FIELD

The present disclosure relates to the technical field of multimedia, in particular to a method and a device for playback optimization.

### BACKGROUND

For playback devices such as television sets, the suppliers for the television sets and the resources are usually independent during the play. Specifically, TV set manufacturers often provide television devices compatible with various resources only, while resource suppliers such as TV stations often provide multimedia resources that can be played on various playback devices only. Mostly a TV set uses fixed display parameters. However, playback with such fixed parameters may not be suitable for all the multimedia resources. The separation of playback devices and multimedia resources usually makes it difficult to achieve the best playback results, and cannot take full advantages of the hardware.

Some TV sets give access to some video quality adjusting parameters, such as contrast, saturation, brightness, noise reduction, sharpness, motion compensation, etc. Some TV sets also give access to some audio quality adjusting parameters, such as noise reduction, surround sound and so on. These are provided for the users to adjust the video and audio modes at will.

However, video quality adjustment is a rather specialized job, and different adjustments are usually required for different images. The results of adjustments by the user may not be satisfying, impacting the visual effect and the sensory experience. In addition, the users would be reluctant to spend time and effort on the adjustments.

### SUMMARY

In one aspect, in general, the present disclosure describes techniques to exert hardware advantages and improve the playback effects on multimedia resources in the playback.

In another aspect of the present disclosure, there is described a method for playback optimization, comprising:

upon receiving a request from a client, querying whether an optimized playback parameter related to a multimedia resource has been stored, wherein the request is associated with the multimedia resource; and

if the optimized playback parameter has been stored, transmitting the optimized playback parameter to the client, so as to have the multimedia resource played by the client according to the optimized playback parameter.

Aspects can include one or more of the following features.

Regarding this method, in one possible implementation, the method further comprises:

generating the optimized playback parameter related to the multimedia resource according to a scene feature contained in the multimedia resource, and storing the optimized playback parameter.

Regarding this method, in one possible implementation, generating the optimized playback parameter related to the multimedia resource according to the scene feature contained in the multimedia resource includes:

selecting first sub-segments from the multimedia resource according to the scene feature contained in the multimedia resource, and recording a first time information for each first sub-segment;

setting respectively a first optimized playback parameter for said each first sub-segment, and generating the optimized playback parameter related to the multimedia resource based on the first optimized playback parameters and the first time information.

Regarding this method, in one possible implementation, generating the optimized playback parameter related to the multimedia resource according to the scene feature contained in the multimedia resource includes:

selecting from the multimedia resource second sub-segments where a specific scene feature appears repeatedly, and recording a second time information at which each second sub-segment appears;

setting a second optimized playback parameter for said each second sub-segment, and generating the optimized playback parameter related to the multimedia resource based on the second optimized playback parameters and the second time information.

Regarding this method, in one possible implementation, generating the optimized playback parameter related to the multimedia resource according to the scene feature contained in the multimedia resource includes:

according to a scene feature preset for the multimedia resource, generating the optimized playback parameter related to the multimedia resource for the entire multimedia resource.

Regarding this method, in one possible implementation, the optimized playback parameter includes a video quality optimized playback parameter and/or an audio quality optimized playback parameter.

In another aspect of the present disclosure, there is described with a method for playback optimization, comprising:

transmitting a request for acquiring an optimized playback parameter related to a multimedia resource to a server;

receiving the optimized playback parameter from the server;

playing the multimedia resource according to the optimized playback parameter.

Aspects can include one or more of the following features.

Regarding this method, in one possible implementation, the method further comprises:

playing the multimedia resource according to a preset playback parameter when the optimized playback parameter has not been received from the server.

Regarding this method, in one possible implementation, the method further comprises:

when the playback of the multimedia resource is finished, restoring a preset playback parameter.

Regarding this method, in one possible implementation, the optimized playback parameter includes a video quality optimized playback parameter and/or an audio quality optimized playback parameter.

In another aspect of the present disclosure, there is described a device for playback optimization, comprising:

a parameter querying module, configured to query, upon receiving a request from a client, whether an optimized playback parameter related to a multimedia resource has been stored, wherein the request is associated with the multimedia resource;

a parameter transmitting module connected to the parameter querying module, configured to transmit, if the optimized playback parameter has been stored, the optimized playback parameter to the client, so as to have the multimedia resource played by the client according to the optimized playback parameter.

Aspects can include one or more of the following features.

Regarding this device, in one possible implementation, the device further comprises:

a parameter generating module, configured to generate the optimized playback parameter related to the multimedia resource according to a scene feature contained in the multimedia resource and store the optimized playback parameter.

Regarding this device, in one possible implementation, the parameter generating module is specifically used for:

selecting first sub-segments from the multimedia resource according to the scene feature contained in the multimedia resource, and recording a first time information for each first sub-segment;

setting respectively a first optimized playback parameter for said each first sub-segment, and generating the optimized playback parameter related to the multimedia resource based on the first optimized playback parameters and the first time information.

Regarding this device, in one possible implementation, the parameter generating module is specifically used for:

selecting from the multimedia resource second sub-segments where a specific scene feature appears repeatedly and recording a second time information at which each second sub-segment appears;

setting a second optimized playback parameter for said each second sub-segment, and generating the optimized playback parameter related to the multimedia resource based on the second optimized playback parameters and the second time information.

Regarding this device, in one possible implementation, the parameter generating module is specifically used for:

according to a scene feature preset for the multimedia resource, generating the optimized playback parameter related to the multimedia resource for the entire multimedia resource.

Regarding this device, in one possible implementation, the optimized playback parameter includes a video quality optimized playback parameter and/or an audio quality optimized playback parameter.

In another aspect of the present disclosure, there is described a device for playback optimization, comprising:

a request transmitting module, configured to transmit a request for acquiring an optimized playback parameter related to a multimedia resource to a server;

a parameter receiving module, configured to receive the optimized playback parameter from the server;

a first playback module connected to the parameter receiving module, configured to play the multimedia resource according to the optimized playback parameter.

Aspects can include one or more of the following features.

Regarding this device, in one possible implementation, the device further comprises:

a second playback module, configured to play the multimedia resource according to a preset playback parameter when the optimized playback parameter has not been received from the server.

Regarding this device, in one possible implementation, the device further comprises:

a parameter restoring module, configured to restore a preset playback parameter when the playback of the multimedia resource is finished.

Regarding this device, in one possible implementation, the optimized playback parameter includes a video quality optimized playback parameter and/or an audio quality optimized playback parameter.

The method for playback optimization of the embodiments of the present disclosure can have one or more advantages, including for example, to enable playback of a multimedia resource according to an optimized playback parameter related to the multimedia resource, and thus exert hardware advantages and improve the playback effects in the playback of multimedia resources.

Other features and aspects will be made clear by detailed description of exemplary embodiments with reference to the following attached drawings.

### BRIEF DESCRIPTION OF THE DRAWINGS

The attached drawings included in and constituting a part of the description together with the description illustrate exemplary embodiments, features, and aspects of the present disclosure, and are used to explain the principles of the present disclosure.

FIG. 1 shows a flowchart of a method for playback optimization according to an embodiment of the present disclosure.

FIG. 2 shows another flowchart of a method for playback optimization according to an embodiment of the present disclosure.

FIG. 3 shows another flowchart of a method for playback optimization according to an embodiment of the present disclosure.

FIG. 4 shows a flowchart of a method for playback optimization according to another embodiment of the present disclosure.

FIG. 5 shows a flowchart of a method for playback optimization according to another embodiment of the present disclosure.

FIG. 6 shows a flowchart of a method for playback optimization according to another embodiment of the present disclosure.

FIG. 7 shows a structural diagram of a device for playback optimization according to an embodiment of the present disclosure.

FIG. 8 shows another structural diagram of a device for playback optimization according to an embodiment of the present disclosure.

FIG. 9 shows a structural diagram of a device for playback optimization according to another embodiment of the present disclosure.

FIG. 10 shows another structural diagram of a device for playback optimization according to another embodiment of the present disclosure.

FIG. 11 shows a structural diagram of an apparatus for playback optimization according to another embodiment of the present disclosure.

### DETAILED DESCRIPTION

Various exemplary embodiments, features, and aspects of the present disclosure will be described in detail with reference to the attached drawings. Same reference numbers in the drawings indicate elements of the same or similar functions. Although various aspects of the embodiments are shown in the attached drawings, unless otherwise specified, the drawings are not necessarily drafted in proportion.

Herein, the special term “exemplary” means “used as an example, an embodiment, or illustration”. Any embodiment described to be “exemplary” here shall not necessarily to be interpreted as preferable or better as compared to other embodiments.

In addition, to better describe the present disclosure, numerous details are provided in the embodiments described below. A person skilled in the art should understand that, the present disclosure can be implemented without some of the details. In some embodiments, methods, means, elements and circuits known by a person skilled in the art are not described in detail, so as to emphasize the subject of the present disclosure.

### Embodiment 1

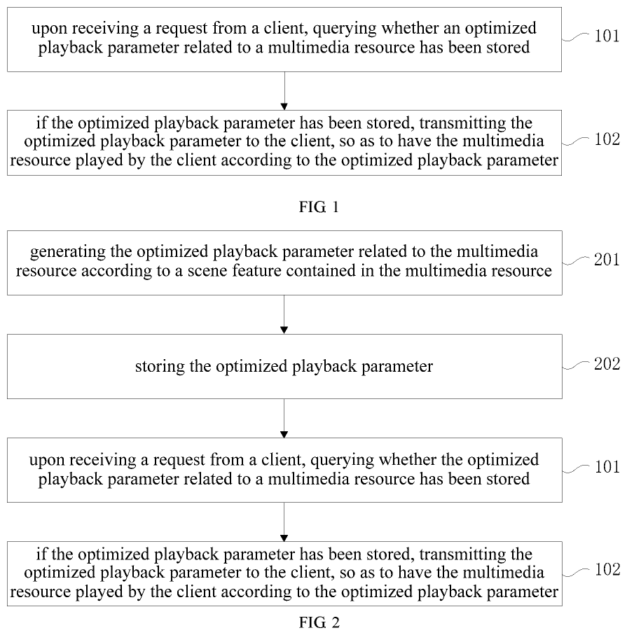

FIG. 1 shows a flowchart of a method for playback optimization according to an embodiment of the present disclosure. As shown in FIG. 1, the method for playback optimization may mainly include:

Step 101 of, upon receiving a request from a client, querying whether an optimized playback parameter related to a multimedia resource has been stored, wherein the request is associated with the multimedia resource; and

Step 102 of, if the optimized playback parameter has been stored, transmitting the optimized playback parameter to the client, so as to have the multimedia resource played by the client according to the optimized playback parameter.

Wherein, the client usually refers to a program or device providing a local service for clients. The client in this embodiment refers to a playback program or device capable of playing a multimedia resource, the playback device including, but not limited to, network television set, computer, tablet computer, mobile phone and the likes. Multimedia is a combination of multiple kinds of media, generally including multiple media formats such as texts, sounds, videos and pictures. The playback parameter may include a video quality playback parameter and/or an audio quality playback parameter. Specifically, the video quality playback parameter may include parameters such as contrast, saturation, brightness, noise reduction, sharpness, and motion compensation. The audio quality playback parameter may include parameters such as surround sound and sharpness.

In one possible implementation, an optimized playback parameter includes a video quality optimized playback parameter and/or an audio quality optimized playback parameter.

Specifically, the optimized playback parameter refers to a playback parameter set for optimizing the playback effects of the multimedia resource. For example, corresponding parameters such as contrast and saturation may be set for a video resource, so that the picture of the video can be clearer and the color can be more saturated, achieving better playback effects in terms of video quality. A corresponding surround sound mode can be set for an audio resource, so that the sound of video propagates in a multi-channel manner, achieving better playback effects in terms of audio quality. The optimized playback parameter can include a corresponding video quality optimized playback parameter and a corresponding audio quality optimized playback parameter, or can include one of the video quality optimized playback parameter and the audio quality optimized playback parameter.

The request may be associated with the multimedia resource in any suitable manner as needed. For example, the request can include various forms such as a request for an on-demand playback on the multimedia resource or a request for acquiring an optimized playback parameter related to the multimedia resource. The request may contain identification information of the multimedia resource, such as the name and the serial number of the multimedia resource.

Specifically, when the client does not store a multimedia resource, the client needs to obtain simultaneously from the server both the multimedia resource and the related optimized playback parameters. At this point, the client transmits a request for an on-demand playback on the multimedia resource to the server, and the server queries whether an optimized playback parameter related to the multimedia resource has been stored. If the optimized playback parameter has been stored, the multimedia resource and the optimized playback parameter are transmitted to the client, so that the client plays the multimedia resource according to the optimized playback parameter.

Further, when the client stores the multimedia resource, the client often only needs to obtain the optimized playback parameter related to the multimedia resource from the server. At this time, the client transmits to the server a request for acquiring an optimized playback parameter related to the multimedia resource; and the server queries whether the optimized playback parameter related to the multimedia resource has been stored. If the optimized playback parameter has been stored, the optimized playback parameter is transmitted to the client, so that the client plays the multimedia resource according to the optimized playback parameter.

In one possible implementation, as shown in FIG. 2, the method for playback optimization may further include:

Step 201 of generating the optimized playback parameter related to the multimedia resource according to a scene feature contained in the multimedia resource; and

Step 202 of storing the optimized playback parameter.

It should be noted that there are many ways to generate the optimized playback parameter related to the multimedia resource. For example, it can be obtained by manual empirical adjustment or from analysis and calculation by a background application. This embodiment does not limit the manner of generation for the optimized playback parameter. In addition, after the optimized playback parameter related to the multimedia resource is generated, it is stored to the server.

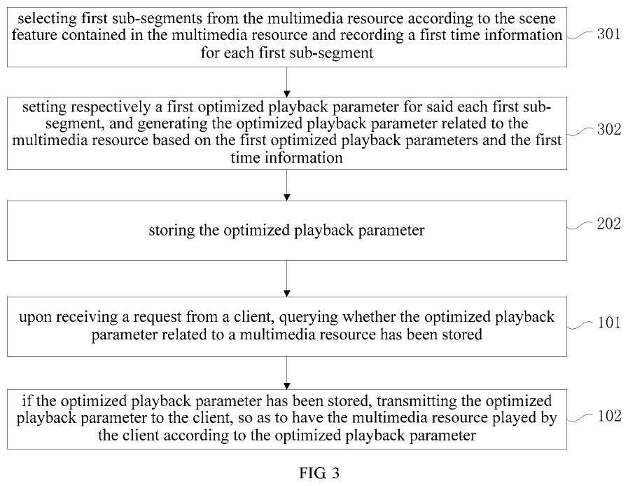

Further, in one possible implementation, as shown in FIG. 3, generating the optimized playback parameter related to the multimedia resource according to the scene feature contained in the multimedia resource (Step 201) may specifically include:

Step 301 of selecting first sub-segments from the multimedia resource according to the scene feature contained in the multimedia resource and recording a first time information for each first sub-segment; and

Step 302 of setting respectively a first optimized playback parameter for said each first sub-segment, and generating the optimized playback parameter related to the multimedia resource based on the first optimized playback parameters and the first time information.

In this embodiment, the scene may refer to a scene in the multimedia resource composed of objects such as characters and environments. The term “scene feature” used herein refers to features that can characterize the scene, such as character object features (e.g., features of clothing, features on the number of characters, etc.), environmental object features (e.g., sky, grass, special building, rain, snow, sunny weather, etc.), content features (e.g., features on the idea, theme and effects to be expressed by the scene), and dynamic features (e.g., predominant motion scenes, predominant static scenes, etc.). The scene features contained in the multimedia resource can be identified, for example, manually or automatically by a program, which is not limited in the present disclosure.

This embodiment does not limit the manner for selecting the first sub-segments from the multimedia resource. For example, the first sub-segments can be selected according to the feature on the idea to be expressed by the scene, or according to the feature on the effect to be achieved by the scene. The first time information can be the start and end time of the playback for each first sub-segment, or a playback period including the start and end time for each first sub-segment.

An exemplary description is given by taking a movie as an example. A scene in the movie often contains the idea that the director wants to express. In order to express the original ideas of the movie to the largest extent, first sub-segments can be selected according to the scene features included in the movie. For example, according to the environmental features of a scene, sub-segments of a dim scene, a misty scene and a snowing or raining scene may be selected, and the start and end times of the three first sub-segments are respectively recorded, for example, as 8:02 to 9:15, 17:38 to 19:42, and 45:29 to 50:22 (Step 301). Optimized playback parameters can be generated for the three sub-segments respectively. For example, for the sub-segment of dim scene, the dynamic backlight can be adjusted so that the picture is dark enough; the sharpness can be lowered for the sub-segment of sly scene; and the noise reducing function can be lowered for the sub-segment of snow or rain scene. The optimized playback parameters for the three first sub-segments are arranged in an order of the start and end times 8:02 to 9:15, 17:38 to 19:42, and 45:29 to 50:22, to generate an optimized playback parameter related to the movie (Step 302); wherein, on the playback timeline of the movie, the starting and ending times, for example, 8:02 to 9:15, 17:38 to 19:42, and 45:29 to 50:22, refer to the times from the start of the playback for the movie to the start or end of the playback for each of the first sub-segments. The optimized playback parameter related to the movie is stored to the server (Step 202). When receiving a request from the client for playing the movie, it is queried whether the optimized playback parameter related to the movie has been stored (Step 101). The optimized playback parameter related to the movie is transmitted to the client, so that the client plays the movie according to the optimized playback parameter (Step 102).

The method for playback optimization of embodiments of the present disclosure allows hardware advantage to be brought into play in the process of multimedia resource playback, thus enhancing playback effects. Moreover, an assessment of the content of the entire multimedia resource can be performed, thus emphasizing an idea being expressed by a picture, and enhancing comprehension of the content of the picture.

### Embodiment 2

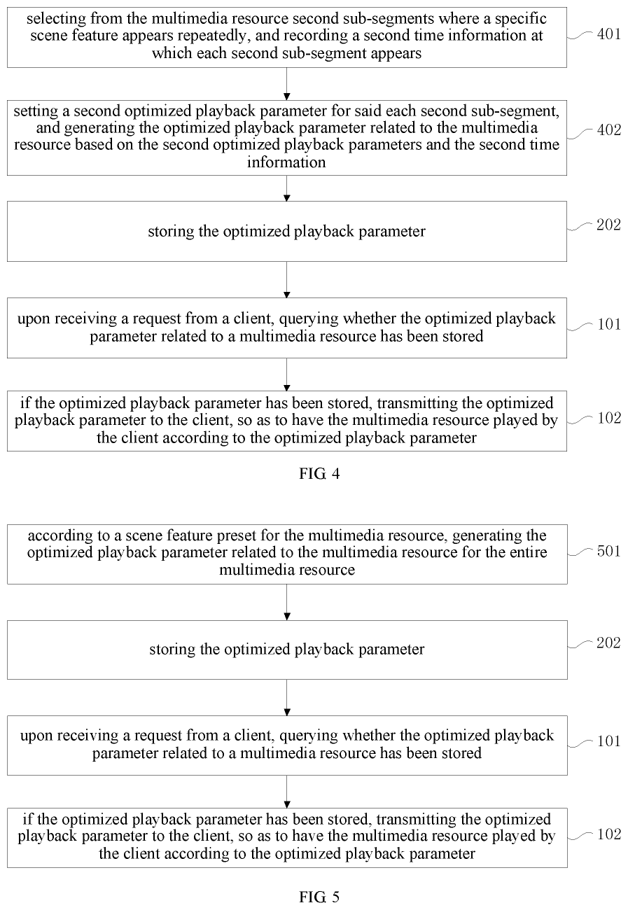

FIG. 4 shows a flowchart of a method for playback optimization according to another embodiment of the present disclosure. Steps shown in FIG. 4 have the same meanings as those in FIGS. 1 to 3 with the same reference numbers. To be concise, detailed description of these steps are omitted.

Different from the foregoing method embodiment, as shown in FIG. 4, in this embodiment, generating the optimized playback parameter related to the multimedia resource according to the scene feature contained in the multimedia resource (Step 201) may specifically include:

Step 401 of selecting from the multimedia resource second sub-segments where a specific scene feature appears repeatedly, and recording a second time information at which each second sub-segment appears; and

Step 402 of setting a second optimized playback parameter for said each second sub-segment, and generating the optimized playback parameter related to the multimedia resource based on the second optimized playback parameters and the second time information.

An exemplary description is given by taking a teleplay as an example. In the scenes of the teleplay, scene features such as clothes and palaces are often repeated. In order to make the picture clearer and the colors more saturated, hence improving the playback effects, second sub-segments having a specific scene feature appearing repeatedly can be selected from the teleplay. For example, second sub-segments where the clothes of the main character appear repeatedly are selected, and the start and end time of each second sub-segment in each episode is recorded, for example, 5:02 to 6:09 and 40:15 to 42:12 in episode one, 16:09 to 18:21 and 18:32 to 23:20 in episode two, etc. (Step 401). For the second sub-segments with the clothes of the main character repeated, parameters such as contrast, saturation etc. can be adjusted, to make the color of the clothes more saturated. The optimized playback parameters for the repeated second sub-segments are arranged in an order of the start and end times thereof in each episode, for example, 5:02 to 6:09 and 40:15 to 42:12 in episode one, 16:09 to 18:21 and 18:32 to 23:20 in episode two, etc., to generate optimized playback parameters related to each episode of the teleplay. Further, the optimized playback parameters related to each episode of the teleplay constitutes an optimized playback parameter related to the teleplay (Step 402); wherein, on the playback timeline of the teleplay, the start and end times, for example, 5:02 to 6:09, 40:15 to 42:12 in episode one, refer to the time from the time the teleplay playback begins to the time the playback of the second sub-segment starts or ends the start of the playback for episode one of the teleplay to the start or end of the playback for each of the first sub-segments. The optimized playback parameter related to the teleplay is stored to the server (Step 202). When receiving a request from the client for playing the teleplay, it is queried whether the optimized playback parameter related to the teleplay has been stored (Step 101). The optimized playback parameter related to the teleplay is transmitted to the client so that the client plays the teleplay according to the optimized playback parameter (Step 102).

The method for playback optimization of embodiments of the present disclosure allows hardware advantage to be brought into play in the process of multimedia resource playback, thus enhancing playback effects. Further, sub-segments with the specific particular scene feature repeated in the entire multimedia resource can be configured in consistency. For example, parameter adjustment can be performed for the clothing of a major character repeatedly appearing in the teleplay, so that the pictures become clearer, and the colors can be more saturated, achieving better picture quality playback effects.

### Embodiment 3

FIG. 5 shows a flowchart of a method for playback optimization according to another embodiment of the present disclosure. Steps shown in FIG. 5 have the same meanings as those in FIGS. 1 to 4 with the same reference numbers. To be concise, detailed description of these steps are omitted.

Different from the above-described method embodiments, as shown in FIG. 5, generating an optimized playback parameter related to the multimedia resource according to the scene feature contained in multimedia resource (Step 201) may specifically include:

Step 501 of, according to a scene feature preset for the multimedia resource, generating the optimized playback parameter related to the multimedia resource for the entire multimedia resource.

An exemplary description is given by taking an online broadcasting program as an example. Usually, the scene feature of the content of the online broadcasting program, like a football game, can be known in advance. For example, green grass filed may be displayed in most screens, and there are numerous fast-moving scenes. An optimized playback parameter related to the online broadcasting football game can be generated for the entire broadcasting program of the football game. For example, parameters of contrast, saturation and others can be adjusted for the green grass field, to obtain more vivid colors. With regard to the fast-moving scenes, the motion compensation function of the playback device can be enabled to make the pictures clear and smooth, improving the playback effects (Step 501). The optimized playback parameter related to the online broadcasting of the football game is stored to the server (Step 202). When receiving a request from the client on the online broadcasting of the football game, it is queried whether the optimized playback parameter related to the online broadcasting of the football game is stored (Step 101). The optimized playback parameter related to the online broadcast of the football game is transmitted to the client, so that the client plays the football game according to the optimized playback parameter (Step 102).

Similarly, for an online broadcasting of a concert, a corresponding audio quality optimized playback parameter can be generated, for example, by setting a surround sound mode. The audio quality can be dynamically adjusted in an independent manner, or together with the video quality.

The method for playback optimization of embodiments of the present disclosure allows hardware advantage to be brought into play in the process of multimedia resource playback, thus enhancing playback effects. Further, a playback parameter can be set for a preset scene feature. For example, by adjusting the parameters for the green grass field and the fast motions in the online broadcasting of the football game, the broadcasting pictures can be vivid, clear, and smooth, achieving better playback effects in the video quality.

### Embodiment 4

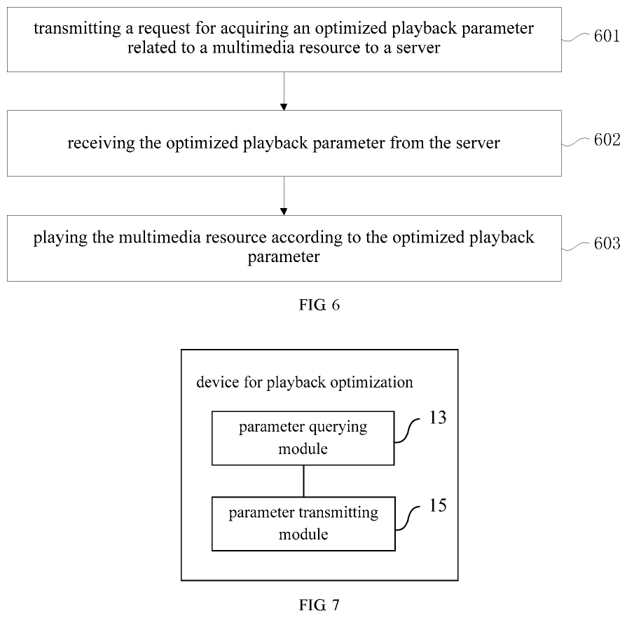

FIG. 6 shows a flowchart of a method for playback optimization according to another embodiment of the present disclosure. As shown in FIG. 6, the method for playback optimization mainly includes:

Step 601 of transmitting a request for acquiring an optimized playback parameter related to a multimedia resource to a server;

Step 602 of receiving the optimized playback parameter from the server; and

Step 603 of playing the multimedia resource according to the optimized playback parameter.

The request for the optimized playback parameter related to the multimedia resource can contain various forms including a request for an on-demand playback on the multimedia resource or a request for acquiring an optimized playback parameter related to the multimedia resource. The request contains identification information of the multimedia resource, such as the name and the serial number of the multimedia resource. Detailed principles and examples can be found in the related description of Embodiment 1.

In one possible implementation, when no optimized playback parameter is received from server, the multimedia resource can be played according to a preset playback parameter.

In one possible implementation, when the playback of the multimedia resource is finished, a preset playback parameter is restored, wherein the preset playback parameter can be a parameter of factory settings of the playback device or a parameter set by user's adjustment.

An exemplary description is given with an example where the playback device is an Internet TV set. Internet TV set manufacturers can adjust different optimized playback parameters for different models of TV set with regard to the same multimedia resource. For example, the Internet TV set transmits to the server a request for an on-demand playback on a movie (Step 601) and if the optimized playback parameter related to the movie is received from the server (Step 602), the movie will be played according to the optimized playback parameter (Step 603). In the case that no optimized playback parameter related to the movie is received from the server, the movie will be played according to a preset playback parameter. If the playback of the movie the movie is finished, the preset playback parameter will be restored.

The method for playback optimization of embodiments of the present disclosure allows hardware advantage to be brought into play in the process of multimedia resource playback, thus enhancing playback effects.

### Embodiment 5

FIG. 7 shows a structural diagram of a device for playback optimization according to an embodiment of the present disclosure. As shown in FIG. 7, the device mainly comprises: a parameter querying module 13 used for querying, upon receiving a request from a client, whether an optimized playback parameter related to a multimedia resource has been stored, wherein the request is associated with the multimedia resource; a parameter transmitting module 15 connected to the parameter querying module 13, used for transmitting, if the optimized playback parameter has been stored, the optimized playback parameter to the client, so as to have the multimedia resource played by the client according to the optimized playback parameter. The detailed principles and examples can be found in the related descriptions of Embodiment 1 and FIG. 1.

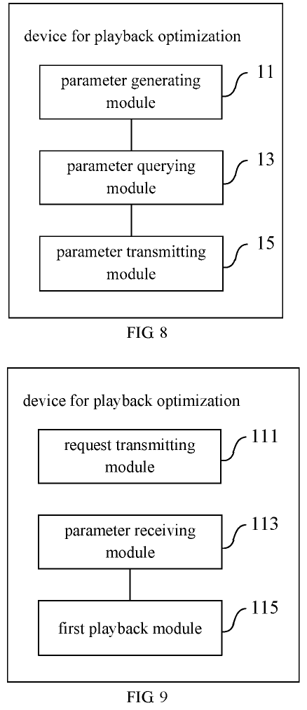

In one possible implementation, as shown in FIG. 8, the device further comprises: a parameter generating module 11, used for generating the optimized playback parameter related to the multimedia resource according to a scene feature contained in the multimedia resource and storing the optimized playback parameter. The detailed principles and examples can be found in the related descriptions of Embodiment 1 and FIG. 2.

In one possible implementation, the parameter generating module 11 is specifically used for selecting first sub-segments from the multimedia resource according to the scene feature contained in the multimedia resource, and recording a first time information for each first sub-segment; and setting respectively a first optimized playback parameter for said each first sub-segment, and generating the optimized playback parameter related to the multimedia resource based on the first optimized playback parameters and the first time information. The detailed principles and examples can be found in the related descriptions of Embodiment 1 and FIG. 3.

In one possible implementation, the parameter generating module 11 is specifically used for selecting from the multimedia resource second sub-segments where a specific scene feature appears repeatedly and recording a second time information at which each second sub-segment appear; and setting a second optimized playback parameter for said each second sub-segment, and generating the optimized playback parameter related to the multimedia resource based on the second optimized playback parameters and the second time information. The detailed principles and examples can be found in the related descriptions of Embodiment 2 and FIG. 4.

In one possible implementation, the parameter generating module 11 is specifically used for, according to a scene feature preset for the multimedia resource, generating the optimized playback parameter related to the multimedia resource for the entire multimedia resource. The detailed principles and examples can be found in the related descriptions of Embodiment 3 and FIG. 5.

In one possible implementation, the optimized playback parameter includes a video quality optimized playback parameter and/or an audio quality optimized playback parameter.

The device for playback optimization of this embodiment of the present disclosure allows hardware advantage to be brought into play in the process of multimedia resource playback, thus enhancing playback effects. Moreover, an assessment of the content of the entire multimedia resource can be performed, thus emphasizing an idea being expressed by a picture, and enhancing comprehension of the content of the picture.

### Embodiment 6

FIG. 9 shows a structural diagram of a device for playback optimization according to another embodiment of the present disclosure. As shown in FIG. 9, the device mainly comprises: a request transmitting module 111, used for transmitting a request for obtaining an optimized playback parameter related to a multimedia resource to a server; a parameter receiving module 113, used for receiving the optimized playback parameter from the server; and a first playback module 115 connected to the parameter receiving module 113, used for playing the multimedia resource according to the optimized playback parameter. The detailed principles and examples can be found in the related description of Embodiment 4 and FIG. 6.

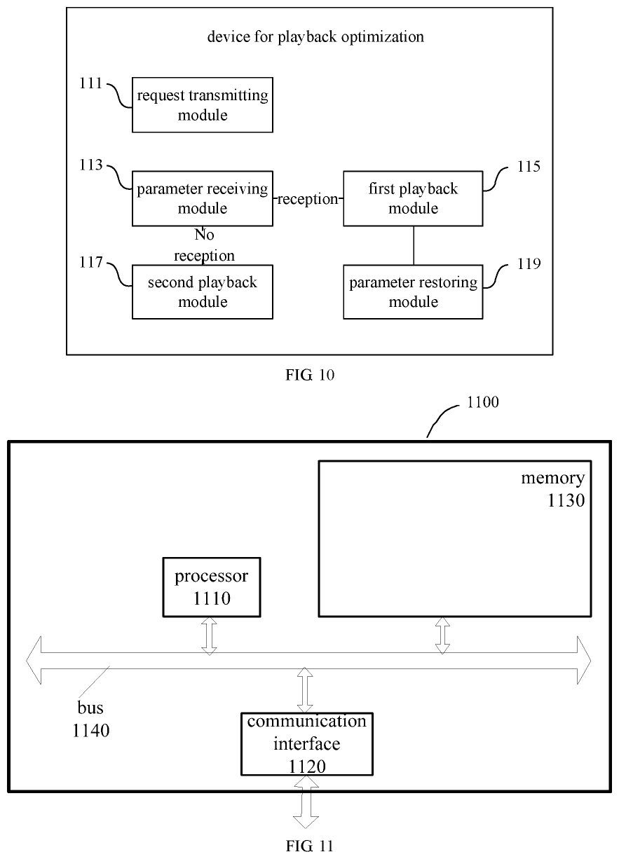

In one possible implementation, as shown in FIG. 10, the device further comprises: a second playback module 117, used for playing the multimedia resource according to a preset playback parameter when the optimized playback parameter has not been received from the server.

In one possible implementation, as shown in FIG. 10, the device further comprises: a parameter restoring module 119, used for restoring a preset playback parameter when the playback of the multimedia resource is finished.

In one possible implementation, the optimized playback parameter includes a video quality optimized playback parameter and/or an audio quality optimized playback parameter.

The device for playback optimization of this embodiment of the present disclosure provides unique optimized playback effects for particular multimedia resources, and allows hardware advantage to be brought into play in the process of multimedia resource playback, thus enhancing playback effects.

### Embodiment 7

FIG. 11 shows a structural diagram of an apparatus for playback optimization according to another embodiment of the present disclosure. The apparatus for playback optimization 1100 can be a host server with computing capability, a personal computer PC, a portable laptop or terminal, etc. The specific embodiments of the present disclosure do not limit the specific implementation of the computing node.

The apparatus for playback optimization 1100 includes a processor 1110, a communication interface 1120, a memory 1130, and a bus 1140, wherein the processor 1110, the communication interface 1120, and the memory 1130 communicate with each other via the bus 1140.

The communication interface 1120 is configured to communicate with network devices including, for example, a virtual machine management center, a shared memory, and the like.

The processor 1110 is configured to execute program. The processor 1110 can be a central processing unit CPU, or an application specific integrated circuit (ASIC), or one or more integrated circuits configured to implement the embodiments of the present disclosure.

The memory 1130 is configured to store files. The memory 1130 can include a high speed RAM, and can further include a non-volatile memory such as at least one disk memory. The memory 1130 can also be an array of memory. The memory 1130 can be partitioned into blocks that can be combined into a virtual volume according to certain rules.

In one possible implementation, the foregoing program can be program codes including computer operational instructions. The program can be specifically applied for enabling the operations of each of the steps in Embodiments 1 to 4.

Those of ordinary skill in the art will appreciate that the various exemplary units and algorithm steps in the embodiments described herein can be implemented in electronic hardware or a combination of computer software and electronic hardware. Implementing these functions in hardware or software depends on the specific application and design constraints of the technical solution. A person skilled in the art can select different methods for implementing the described functions with regard to particular applications, while such implementations should not be considered to be beyond the scope of the present disclosure.

If the functions are implemented in the form of computer software and sold or used as a stand-alone product, it somehow can be deemed that all or part of the technical solution of the present disclosure (for example, the part contributing to the prior art) is embodied in the form of a computer software product. The computer software product is typically stored in a computer readable non-volatile storage medium, including instructions causing a computer device (which may be a PC, a server, a network device, etc.) to execute all or a part of the steps of the method according to embodiments of the present disclosure. The storage medium includes various media that can store program codes, such as a USB flash drive, a removable hard disk, a read-only memory (ROM), a random access memory (RAM), a magnetic disk, or an optical disk.

The foregoing described is merely embodiments of the present disclosure. The protection scope of the present disclosure is not limited therewith. Any technician skilled in this art may understand that any modification and replacement readily conceived within the technical scope revealed by the present disclosure should be included within the protection scope. Therefore, the scope of the present disclosure is intended to be limited by the appended claims.

1. A method for playback optimization, comprising:
upon receiving a request from a client, querying whether an optimized playback parameter related to a multimedia resource has been stored, wherein the request is associated with the multimedia resource; and
if the optimized playback parameter has been stored, transmitting the optimized playback parameter to the client, so as to have the multimedia resource played by the client according to the optimized playback parameter.

2. The method according to claim 1, wherein the method further comprises:
generating the optimized playback parameter related to the multimedia resource according to a scene feature contained in the multimedia resource, and storing the optimized playback parameter, wherein the scene feature being a feature capable of characterizing the scene.

3. The method according to claim 2, wherein generating the optimized playback parameter related to the multimedia resource according to the scene feature contained in the multimedia resource comprises:
selecting first sub-segments from the multimedia resource according to the scene feature contained in the multimedia resource, and recording a first time information for each first sub-segment; and
setting respectively a first optimized playback parameter for said each first sub-segment, and generating the optimized playback parameter related to the multimedia resource based on the first optimized playback parameters and the first time information.

4. The method according to claim 2, wherein generating the optimized playback parameter related to the multimedia resource according to the scene feature contained in the multimedia resource comprises:
selecting from the multimedia resource second sub-segments where a specific scene feature appears repeatedly, and recording a second time information at which each second sub-segment appears; and
setting a second optimized playback parameter for said each second sub-segment, and generating the optimized playback parameter related to the multimedia resource based on the second optimized playback parameters and the second time information.

5. The method according to claim 2, wherein generating the optimized playback parameter related to the multimedia resource according to the scene feature contained in the multimedia resource comprises:
according to a scene feature preset for the multimedia resource, generating the optimized playback parameter related to the multimedia resource for the entire multimedia resource.

6. The method according to claim 1, wherein the optimized playback parameter includes a video quality optimized playback parameter and/or an audio quality optimized playback parameter.

7. A method for playback optimization, comprising:
transmitting a request for obtaining an optimized playback parameter related to a multimedia resource to a server;
receiving the optimized playback parameter from the server; and
playing the multimedia resource according to the optimized playback parameter.

8. The method according to claim 7, wherein the method further comprises:
playing the multimedia resource according to a preset playback parameter in a case where the optimized playback parameter has not been received from the server.

9. The method according to claim 7, wherein the method further comprises:
when the playback of the multimedia resource is finished, restoring a preset playback parameter.

10. The method according to claim 7, wherein the optimized playback parameter includes a video quality optimized playback parameter and/or an audio quality optimized playback parameter.

11. A device for playback optimization, comprising:
a parameter querying module configured to query, upon receiving a request from a client, whether an optimized playback parameter related to a multimedia resource has been stored, wherein the request is associated with the multimedia resource; and
a parameter transmitting module connected to the parameter querying module and configured to transmit, if the optimized playback parameter has been stored, the optimized playback parameter to the client, so as to have the multimedia resource played by the client according to the optimized playback parameter.

12. The device according to claim 11, wherein the device further comprises:
a parameter generating module configured to generate the optimized playback parameter related to the multimedia resource according to a scene feature contained in the multimedia resource and store the optimized playback parameter, wherein the scene feature being a feature capable of characterizing the scene.

13. The device according to claim 12, wherein the parameter generating module is specifically configured to:
select first sub-segments from the multimedia resource according to the scene feature contained in the multimedia resource, and record a first time information for each first sub-segment; and
set respectively a first optimized playback parameter for said each first sub-segment, and generate the optimized playback parameter related to the multimedia resource based on the first optimized playback parameters and the first time information.

14. The device according to claim 12, wherein the parameter generating module is specifically configured to:
select from the multimedia resource second sub-segments where a specific scene feature appears repeatedly, and record a second time information at which each second sub-segment appears; and
set a second optimized playback parameter for said each second sub-segment, and generate the optimized playback parameter related to the multimedia resource based on the second optimized playback parameters and the second time information.

15. The device according to claim 12, wherein the parameter generating module is specifically configured to:
according to a scene feature preset for the multimedia resource, generate the optimized playback parameter related to the multimedia resource for the entire multimedia resource.

16. The device according to claim 11, wherein the optimized playback parameter includes a video quality optimized playback parameter and/or an audio quality optimized playback parameter.

17. A device for playback optimization, comprising:
a request transmitting module configured to transmit a request for obtaining an optimized playback parameter related to a multimedia resource to a server;
a parameter receiving module configured to receive the optimized playback parameter from the server; and
a first playback module connected to the parameter receiving module and configured to play the multimedia resource according to the optimized playback parameter.

18. The device according to claim 17, wherein the device further comprises:
a second playback module configured to, in a case where the optimized playback parameter from a server is not received, play the multimedia resource according to a preset playback parameter.

19. The device according to claim 17, wherein the device further comprises:
a parameter restoring module configured to restore a preset playback parameter when the playback of the multimedia resource is finished.

20. The device according to claim 17, wherein the optimized playback parameter includes a video quality optimized playback parameter and/or an audio quality optimized playback parameter.

21. The method according to claim 7, wherein the optimized playback parameter is generated according to a scene feature contained in the multimedia resource, and the scene feature is a feature capable of characterizing the scene

22. The device according to claim 17, wherein the optimized playback parameter is generated according to a scene feature contained in the multimedia resource, and the scene feature is a feature capable of characterizing the scene.
